(19) United States
(12) Patent Application Publication
(10) Pub. No.: US 2014/0173148 A1
(43) Pub. Date: Jun. 19, 2014

(54) APPROACH FOR WORKING AROUND STARVATION PROBLEMS IN A DATAPATH

(71) Applicant: NVIDIA CORPORATION, Santa Clara, CA (US)

(72) Inventors: Dennis Kd Ma, Austin, TX (US); Utpal Barman, Bangalore (IN)

(73) Assignee: NVIDIA CORPORATION, Santa Clara, CA (US)

(21) Appl. No.: 13/715,148

(22) Filed: Dec. 14, 2012

(51) Int. Cl. G06F 13/38

(52) U.S. Cl. CPC G06F 13/38
USPC 710/113

(57) ABSTRACT

A starvation control engine operable to monitor data transactions within a computer system potentially prevents or corrects starvation issues. The starvation control engine is programmed to generate one or more bubbles in a data path based on one or more trigger events. The trigger events or the criteria underlying the trigger events may be programmed or changed by at least one of a user or the starvation control engine. The starvation control engine determines when, for how long, and how often to generate the one or more bubbles based on the type of event.

### BACKGROUND OF THE INVENTION

1. Field of the Invention

Embodiments of the invention generally relate to computer systems and, more specifically, to an approach for working around starvation problems in a data path.

2. Description of the Related Art

In conventional computer systems, “starvation” issues are a fairly common problem. As is well-known, starvation may occur when a process is continuously denied access to a particular shared resource, which prevents work associated with the process from being completed. One form of starvation that exists in data paths may occur when an unbroken stream of data flowing in a data path prevents data associated with a different stream of data in the data path from being processed. For example, a long, unbroken stream of posted or “write” transactions, which are generally given priority over non-posted or “read” transactions, may continuously flow through a data path without permitting any read transaction to be processed, thereby starving the read transaction of a shared resource. For example, the shared resource may be data stored in a graphics processing unit memory buffer for processing the read and write transactions. Another form of starvation is “deadlock,” which may occur when two streams of data in a data path continuously block each other due to the inability of the system to decide which data stream to process first. For example, two transactions, each of which is dependent upon a response from the other, may effectively block each other such that neither of the data streams is processed, thereby creating a deadlock situation.

To combat starvation issues, scheduling algorithms are oftentimes used to allocate shared resources among different processes so that no process is continuously denied such a shared resource. Occasionally, however, starvation issues stem from a poor design, such as a faulty arbitration unit or faulty logic provided somewhere in the system that, in operation, ends up continuously denying a particular process or data associated with a process access to a shared resource. Issues also may stem from faulty communication between arbitration units or logic within a system that were built or designed by different manufacturers, e.g., a computer system having a central processing unit developed by one manufacturer coupled to a graphics card developed by another manufacturer via one or more data paths. For example, the central processing unit designed by one manufacturer may be configured to issue a very large number of write transactions such that an arbiter within the graphics card designed by another manufacturer is unable to effectively process without starving read transactions received from the same central processing unit.

One approach to addressing starvation issues when those issues actually arise in data paths within a computer system is to introduce breaks in the data flow within a data path (known as “bubbles”) to allow the faulty arbitration unit or logic to exit any starvation or deadlock situation. Bubbles may be generated via software or hardware, but each of these approaches has limitations.

Generating bubbles via software requires additional system resources to be implemented and also requires the flow of data in the data path to be continuously monitored and then interrupted, when necessary, with bubbles. Both of these requirements harm overall system performance. Further, generating bubble via software may not even be possible if there is no access to the central processing unit to set up such a paradigm.

Generating bubbles via hardware can be accomplished by throttling the flow of data through the data path such that bubbles are created in the data path at predetermined locations. Such an approach can harm overall performance because bubbles oftentimes are generated in the data flow when unnecessary and because bubbles are sometimes generated at the wrong location in the data path and, consequently, end up not addressing the particular starvation issue at hand.

Accordingly, what is needed in the art is a more effective approach for managing starvation issues in a data path.

### SUMMARY OF THE INVENTION

Embodiments of the invention include a method for managing starvation issues in a computing device. The method comprises monitoring data transactions issued to a destination device by a source device across one or more data paths; detecting a trigger event based on the monitored data transactions; determining a type associated with the trigger event; and generating at least one bubble in a first data path based on the type associated with the trigger event.

Embodiments of the invention include a subsystem configured to manage starvation issues in a computing device. The subsystem comprises a starvation control engine configured to monitor data transactions issued to a destination device by a source device across one or more data paths; detect a trigger event based on the monitored data transactions; determine a type associated with the trigger event; and generate at least one bubble in a first data path based on the type associated with the trigger event.

Embodiments of the invention include a computing device configured to manage starvation issues. The computing device comprises a destination device; a source device in communication with the destination device via one or more data paths; at least one arbiter configured to control data transactions communicated through the one or more data paths; and a starvation control engine configured to monitor the data transactions issued to the destination device by the source device across the one or more data paths; detect a trigger event based on the monitored data transactions; determine a type associated with the trigger event; and generate at least one bubble in a first data path based on the type associated with the trigger event.

Embodiments of the invention include a subsystem configured to manage starvation issues in a computing device. The subsystem comprises a starvation control engine configured to generate at least one bubble in a first data path between a destination device and a source device, wherein at least one of: when to generate at least one bubble, how long to generate at least one bubble, and how often to generate at least one bubble is programmable via the starvation control engine.

One advantage of the embodiments of the invention is to potentially preempt or correct starvation issues in computer systems, thereby enhancing overall computer system performance.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the invention.

FIG. 2 is a block diagram illustrating data paths between a CPU and a GPU within the computer system of FIG. 1, according to one embodiment of the invention.

FIG. 3 is a block diagram illustrating a portion of the data paths from the CPU illustrated in FIG. 2, according to one embodiment of the invention.

FIG. 4 is a flow diagram of method steps for managing starvation in a data path, according to one embodiment of the invention.

### DETAILED DESCRIPTION

In the following description, numerous specific details are set forth to provide a more thorough understanding of the embodiments of the invention. However, it will be apparent to one of skill in the art that the invention may be practiced without one or more of these specific details.

### Computer System Overview

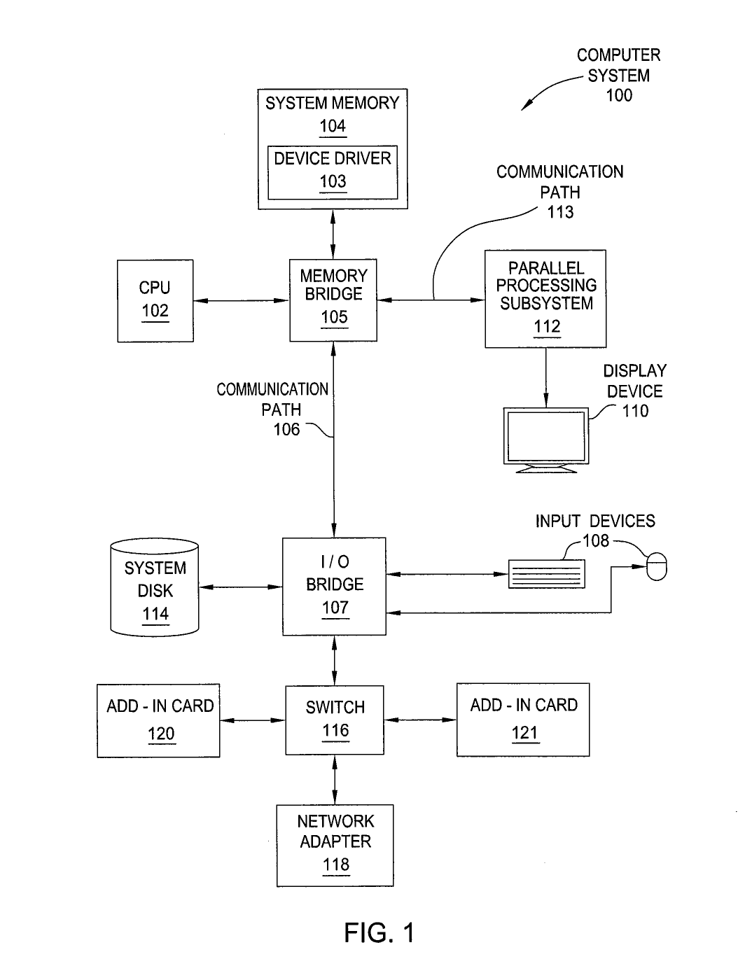

FIG. 1 is a block diagram illustrating a computer system 100 configured to implement one or more aspects of the invention. As shown, computer system 100 includes, without limitation, a central processing unit (CPU) 102 and a system memory 104 that includes a device driver 103, all communicating via an interconnection path that may include a memory bridge 105. Memory bridge 105, which may be, e.g., a Northbridge chip, is connected via a bus or other communication path 106 (e.g., a HyperTransport link) to an I/O (input/output) bridge 107. I/O bridge 107, which may be, e.g., a Southbridge chip, receives user input from one or more user input devices 108 (e.g., keyboard, mouse) and forwards the input to CPU 102 via communication path 106 and memory bridge 105. A parallel processing subsystem 112 is coupled to memory bridge 105 via a bus or second communication path 113 (e.g., a Peripheral Component Interconnect (PCI) Express, Accelerated Graphics Port, or HyperTransport link). In one embodiment, parallel processing subsystem 112 is a graphics subsystem that delivers pixels to a display device 110 that may be any conventional cathode ray tube, liquid crystal display, light-emitting diode display, or the like. A system disk 114 is also connected to I/O bridge 107 and may be configured to store content and applications and data for use by CPU 102 and parallel processing subsystem 112. System disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices.

A switch 116 provides connections between I/O bridge 107 and other components such as a network adapter 118 and various add-in cards 120 and 121. Other components (not explicitly shown), including universal serial bus (USB) or other port connections, compact disc (CD) drives, digital versatile disc (DVD) drives, film recording devices, and the like, may also be connected to I/O bridge 107. The various communication paths shown in FIG. 1, including the specifically named communication paths 106 and 113 may be implemented using any suitable protocols, such as PCI Express, AGP (Accelerated Graphics Port), HyperTransport, or any other bus or point-to-point communication protocol(s). Connections between different devices may also use different protocols as is known in the art.

In one embodiment, the parallel processing subsystem 112 incorporates circuitry optimized for graphics and video processing, including, for example, video output circuitry, and includes one or more graphics processing units (GPUs). In another embodiment, the parallel processing subsystem 112 incorporates circuitry optimized for general purpose processing, while preserving the underlying computational architecture, described in greater detail herein. In yet another embodiment, the parallel processing subsystem 112 may be integrated with one or more other system elements in a single subsystem, such as joining the memory bridge 105, CPU 102, and I/O bridge 107 to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For instance, in some embodiments, system memory 104 is connected to CPU 102 directly rather than through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other embodiments, I/O bridge 107 and memory bridge 105 might be integrated into a single chip instead of existing as one or more discrete devices. Large embodiments may include two or more CPUs 102 and two or more parallel processing subsystems 112. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

In operation, CPU 102 is the master processor of computer system 100, controlling and coordinating operations of other system components. In particular, CPU 102 issues commands that control the operation of the parallel processing subsystem 112. In some embodiments, CPU 102 writes a stream of commands for each the parallel processing subsystem 112 to a data structure that may be located in system memory 104, parallel processing memory 204, or another storage location accessible to both CPU 102 and the parallel processing subsystem 112. A pointer to each data structure is written to a pushbuffer to initiate processing of the stream of commands in the data structure. The parallel processing subsystem 112 reads command streams from one or more pushbuffers and then executes commands asynchronously relative to the operation of CPU 102. Execution priorities may be specified for each pushbuffer by an application program via the device driver 103 to control scheduling of the different pushbuffers.

Persons of ordinary skill in the art will understand that the architecture described in FIGS. 1, 2 and 3 in no way limits the scope of the invention and that the techniques taught herein may be implemented on any properly configured computer system, including, without limitation, one or more CPUs, one or more multi-core CPUs, one or more parallel processing subsystems 112, and one or more GPUs or special purpose processing units, or the like, without departing the scope of the invention.

### Starvation Control Mechanism

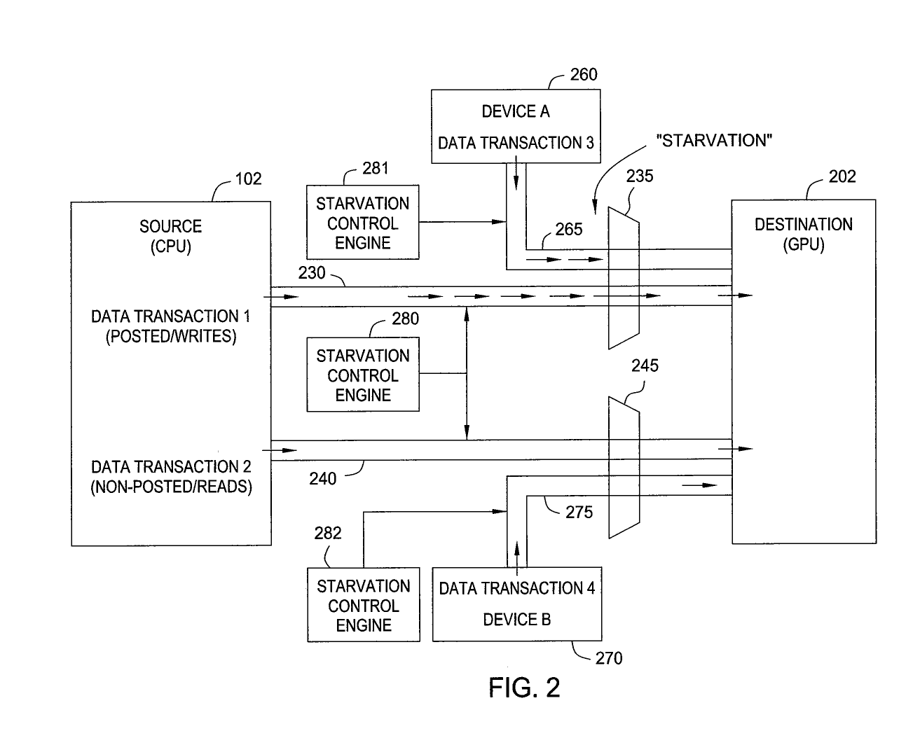

FIG. 2 is a block diagram illustrating data flow paths between a source, e.g. CPU 102, and a destination, e.g. GPU 202, within the computer system of FIG. 1, according to one embodiment of the invention. As shown, a data path 230 is configured to communicate data transactions 1, such as posted write transactions, from the CPU 102 to the GPU 202. A data path 240 is configured to communicate data transactions 2, such as non-posted read transactions, from the CPU 102 to the GPU 202. A posted write transaction is implemented to store data in a specific location, such as a memory buffer, for further processing. A non-posted read transaction is implemented to obtain data from a specific location, such as a memory buffer, for further processing.

As also shown, another data path 265 is configured to communicate data transactions 3 from a device A 260, such as the input devices 108 illustrated in FIG. 1, to the GPU 202. A data path 275 is configured to communicate data transactions 4 from a device B 270, such as the device drive 103 illustrated in FIG. 1, to the GPU 202. The data transactions 3 and the data transactions 4 may be the same types of transactions or different types of transactions as the data transactions 1 and the data transactions 2.

A first arbiter 235 controls the flow of data transactions through the data path 230 and the data path 265. A second arbiter 245 controls the flow of data transactions through the data path 240 and the data path 275. The first arbiter 235 and the second arbiter 245 are electronic devices that allocate access to a shared resource, e.g. the GPU 202. In particular, the first arbiter 235 and the second arbiter 245 select the order that the data transactions access the GPU 202 to prevent the GPU 202 from receiving more than one data transaction at the same time to process. In one embodiment, the first arbiter 235 and the second arbiter 245 may be operable to permit posted/write transactions to access a shared resource before non-posted/read transactions.

The first arbiter 235 is operable to select the order that the data transactions 1 and the data transactions 3 access the GPU 202. As illustrated, the first arbiter 235 is operable to permit a long, unbroken stream of data transactions 1 (e.g. posted/write transactions) from the CPU 102 to access the GPU 202 and, at the same time, prevent the data transactions 3 (e.g. non-posted read transactions) from the device A 260 from access to the GPU 202. To the extent the first arbiter 235 fails to allow any of the data transactions 3 to access the GPU 202 over an extended period of time, the data transactions 3 may become “starved” from access to the GPU 202. Among other things, the data transactions 3 may stall out if the first arbiter 235 continues to deny access to the GPU 202 in view of the long, unbroken stream of data transactions 1 from the CPU 102, thereby impairing the performance of the device A 260.

To preempt such starvation types of situations, a starvation control engine 280 is operable to generate one or more bubbles in the data path 230 to create one or more breaks in the stream of data transactions 1. The bubbles provide the first arbiter 235 with an opportunity to allow the data transactions 3 to access the GPU 202 for processing. In operation, the starvation control engine 280 monitors the data transactions 1 in the data path 230 and generates the bubbles based on one or more trigger events as further described below to potentially prevent or correct a starvation issue. The starvation control engine 280 similarly monitors data transactions 2 and generates bubbles in the data path 240.

In one embodiment, the starvation control engine 280 similarly monitors data transactions 3 and data transactions 4 and generates bubbles in the data path 265 and the data path 275. In another embodiment, a starvation control engine 281 and a starvation control engine 282, each of which are similarly operable as the starvation control engine 280, may monitor data transactions 3 and data transactions 4 and generate bubbles in the data path 265 and the data path 275, respectively. In yet other embodiments, each data path may have one or more starvation control engines monitoring data transactions and generating bubbles in the data path. In yet other embodiments, a single starvation control engine may monitor data transactions and generate bubbles in multiple data paths.

The starvation control engine 280 is configured to determine when, for how long, and/or how often to generate bubbles in the data path 230 and/or the data path 240 when a trigger event is detected and based on the type of trigger event. When the starvation control engine 280 detects a particular trigger event and determines the type of trigger event, the starvation control engine 280 at the appropriate time stops or throttles the stream of data transactions in the data path 230 and/or the data path 240. In particular, the starvation control engine 280 controls the amount of time or the number of cycles to stop or throttle the data transaction streams to generate sufficient numbers and sizes of bubbles in the data path 230 and/or the data path 240 to potentially prevent or correct a starvation issue.

The trigger events may include, but are not limited to, (1) the lapse of a predetermined amount of time or cycles; (2) the processing of an unbroken stream of one type of data transactions (e.g. write transactions) for a predetermined amount of time or cycles without the processing of another type of data transaction (e.g. read transaction); (3) the processing of a predetermined number of one type of data transactions (e.g. write transactions) within a predetermined amount of time or cycles; and (4) the non-processing of a predetermined amount of pending data transactions.

In one embodiment, a user may pre-program the starvation control engine 280 with the criteria underling the trigger events, and may also change the criteria underlying the trigger events. In another embodiment, the starvation control engine 280 may be programmed to change the criteria underlying the trigger events. In yet other embodiments, the criteria underlying the trigger events may be changed based on the frequency or infrequency of one or more of the trigger events and/or one or more of the type, amount, and occurrence of data transactions in a data path.

As an example of the functionalities of the starvation control engines of FIG. 2, the starvation control engine 280 may be programmed to generate a bubble in the data path 230 for X-number of cycles when the starvation control engine 280 detects a continuous stream of Y-number of data transactions 1 in the data path 230. A user may pre-program or change the X and Y values in the starvation control engine 280. Alternatively, or in addition, the starvation control engine 280 may change the X and Y values. The X and Y values may be changed based on the frequency or infrequency of one or more of the trigger events and/or one or more of the type, amount, and occurrence of data transactions in a data path.

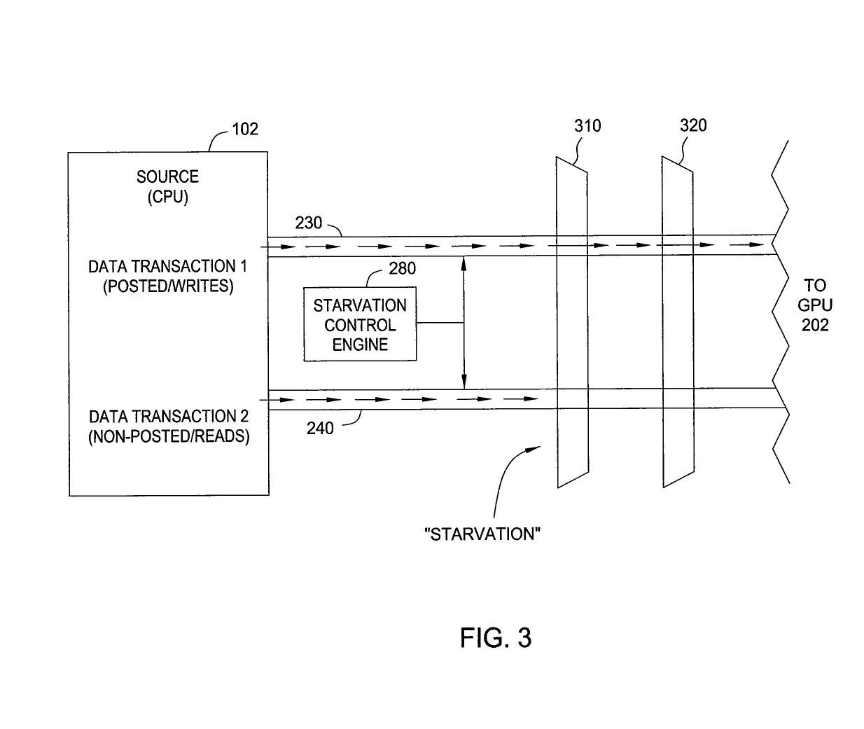

FIG. 3 is a block diagram illustrating a portion of the data paths 230, 240 from the CPU 102 illustrated in FIG. 2, according to one embodiment of the invention. As shown, a third arbiter 310 and a fourth arbiter 320 control the flow of data transactions through the data path 230 and the data path 240. The third arbiter 310 is located upstream from the fourth arbiter 320, or in other words, the data transactions 1 and the data transactions 2 encounter the third arbiter 310 before encountering the fourth arbiter 320.

Similar to the first arbiter 235 and the second arbiter 245, the third arbiter 310 and the fourth arbiter 320 are electronic devices that allocate access to a shared resource, e.g. the GPU 202. In particular, the third arbiter 310 and the fourth arbiter 320 select the order that the data transactions access the GPU 202 to prevent the GPU 202 from receiving more than one data transaction at the same time to process. In one embodiment, the third arbiter 310 and the fourth arbiter 320 may be operable to permit posted/write transactions to access a shared resource before non-posted/read transactions.

As illustrated, the third arbiter 310 is operable to permit a long, unbroken stream of data transactions 1 (e.g. posted/write transactions) from the CPU 102 to access the GPU 202 and, at the same time, prevent the data transactions 2 (e.g. non-posted read transactions) also from the CPU 102 from access to the GPU 202. To the extent the third arbiter 310 fails to allow any of the data transactions 2 to access the GPU 202 over an extended period of time, the data transactions 2 may become “starved” from access to the GPU 202. Among other things, the data transactions 2 may stall out if the third arbiter 310 continues to deny access to the GPU 202 in view of the long, unbroken stream of data transactions 1, thereby impairing the performance of the CPU 102.

To preempt such starvation types of situations, the starvation control engine 280 is operable to generate one or more bubbles in the data path 230 to create one or more breaks in the stream of data transactions 1. The bubbles provide the third arbiter 310 with an opportunity to allow the data transactions 2 to access the GPU 202 for processing. In operation, the starvation control engine 280 monitors the data transactions 1 in the data path 230 and monitors the data transactions 2 in the data path 240, and generates bubbles based on the one or more trigger events described herein to potentially prevent or correct a starvation issue.

According to one example, the starvation control engine 280 may be triggered by the processing of a predetermined number of data transactions 1 (e.g. write transactions) within a predetermined amount of time or number of cycles. According to another example, the starvation control engine 280 may be triggered by the processing of the unbroken stream of data transactions 1 (e.g. write transactions) for a predetermined amount of time or number of cycles without the processing any of the data transactions 2 (e.g. read transaction). According to a further example, the starvation control engine 280 may be triggered by the non-processing of a predetermined amount of pending data transactions 2.

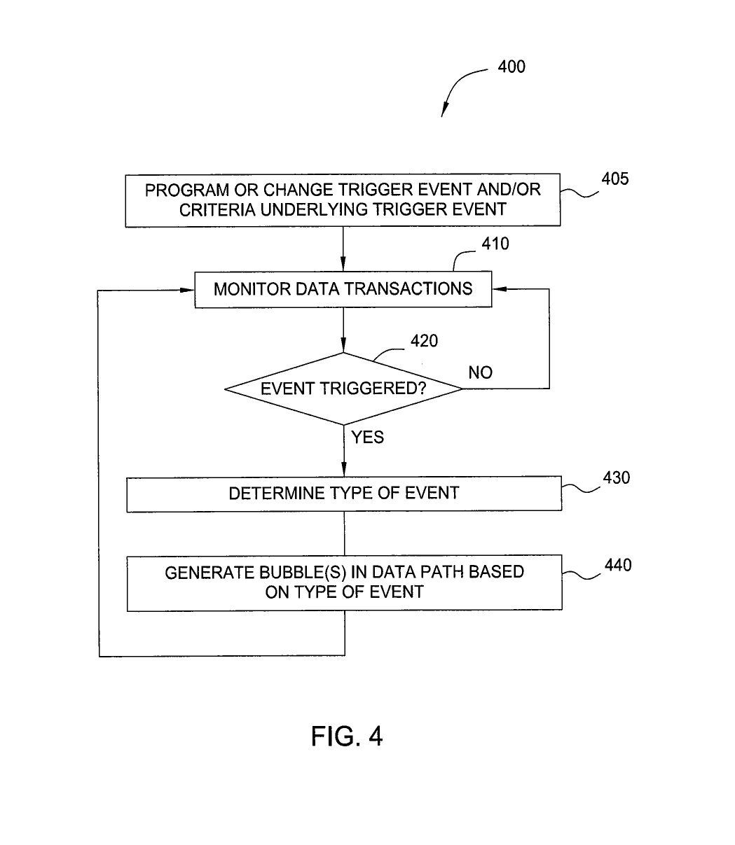

FIG. 4 is a flow diagram of method steps for managing starvation in a data path, according to one embodiment of the invention. Although the method steps are described in conjunction with the systems of FIGS. 1, 2, and 3, persons skilled in the art will understand that any system configured to implement the method steps, in any order, falls within the scope of the invention.

As shown, a method 400 includes an initial step 405 of programming or changing one or more trigger events in the starvation control engine 280, and/or programming or changing the criteria underlying one or more trigger events in the starvation control engine 280. At least one of a user and the starvation control engine 280 may perform the initial step 405. The criteria underlying the trigger events may be changed based on the frequency or infrequency of one or more of the trigger events and/or one or more of the type, amount, and occurrence of data transactions in a data path.

At step 410, the starvation control engine 280 monitors data transactions in one or more data paths until a trigger event is detected. At step 420, if no trigger event occurs, then the starvation control engine 280 continues to monitor the data transactions. At step 420, however, if an event is triggered, then the starvation control engine proceeds to step 430 and determines the type of trigger event. At step 440, the starvation control engine generates one or more bubbles in the requisite data path based on the type of trigger event. Based on the type of trigger event, the starvation control engine 280 is configured to determine when, for how long, and/or how often to generate bubbles in the data paths. After generating one or more bubbles in the data path, the starvation control engine 280 proceeds back to step 410 and continues to monitor data transactions in the data paths until another trigger event is detected.

The method 400 may be repeated any number of times for any number of data transactions sent by a source device, e.g. the CPU 102, to a destination device, e.g. the GPU 202. By generating bubbles in the data paths between the source device and the destination device based on one or more trigger events, the starvation control engine 280 potentially prevents or corrects starvation issues that may impair the performance of one or more computer system components. The starvation control engine 280 thus may enhance overall computer system performance.

In one embodiment, the starvation control engine 280 may be programmed to generate at least one bubble in one or more data paths between a destination device and a source device. The starvation control engine may be programmed to generate the bubble when enabled by a user. The starvation control engine may be programmable to generate a bubble of a desired size and at a desired frequency. One or more of the following parameters may be programmable via the starvation control engine: when to generate at least one bubble in a data path; how long to generate at least one bubble in a data path; and how often to generate at least one bubble in a data path.

In sum, embodiments of the invention include a programmable starvation control engine that monitors streams of data transactions within a data path and preemptively generates bubbles directly in the data path based on one or more trigger events. More specifically, the starvation control engine anticipates a potential or an actual starvation issue based on one or more trigger events and then generates bubbles in the data path in an attempt to prevent the starvation issue. Among other things, the starvation control engine determines when, for how long, and/or how often to generate bubbles in the data path once a trigger event has been detected. In that regard, when a trigger event occurs, the starvation control engine stops the stream of data transactions or throttles the streams of data transactions for a certain amount of time or for a certain number of cycles in order to generate a certain number of bubbles in the data path in an attempt to prevent the starvation event from occurring. In various embodiments, trigger events may include, but are not limited to, (1) the lapse of a predetermined amount of time or cycles; (2) the processing of an unbroken stream of one type of data transactions (e.g. write transactions) for a predetermined amount of time or cycles without the processing of another type of data transaction (e.g. read transaction); (3) the processing of a predetermined number of one type of data transactions (e.g. write transactions) within a predetermined amount of time or cycles; and (4) the non-processing of a predetermined amount of pending data transactions. A user may program and change the criteria underlying the trigger events. In particular, the starvation control engine may be programmed to change the criteria underlying the trigger events based on the frequency or infrequency of one or more of the trigger events and/or one or more of the type, amount, and occurrence of data transactions.

One advantage of the embodiments of the invention is that the techniques disclosed herein can be implemented in an effort to preempt or correct starvation issues in computer systems, thereby enhancing overall computer system reliability and performance.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the invention is set forth in the claims that follow.

1. A method for managing starvation issues in a computing device, the method comprising:
monitoring data transactions issued to a destination device by a source device across one or more data paths;
detecting a trigger event based on the monitored data transactions;
determining a type associated with the trigger event; and
generating at least one bubble in a first data path based on the type associated with the trigger event.

2. The method of claim 1, wherein monitoring data transactions comprises monitoring data transactions issued to the destination device by the source device across the first data path.

3. The method of claim 2, further comprising stopping or throttling the data transactions in the first data path to generate at least one bubble in the first data path.

4. The method of claim 3, wherein the data transactions in the first data path comprise a stream of posted write transactions.

5. The method of claim 1, wherein monitoring data transactions comprises monitoring data transactions issued to the destination device by the source device across a second data path.

6. The method of claim 5, wherein the data transactions in the second data path comprise at least one pending non-posted read transaction.

7. The method of claim 6, further comprising stopping or throttling a stream of posted write transaction in the first data path to generate at least one bubble in the first data path.

8. The method of claim 1, further comprising determining that the type associated with the trigger event comprises at least one of:
(1) a lapse of a predetermined amount of time or cycles;
(2) a processing of an unbroken stream data transactions in the first data path for a predetermined amount of time or cycles without processing a data transaction in a second data path;
(3) a processing of a predetermined number of data transactions in the first data path within a predetermined amount of time or cycles; and
(4) a non-processing of a predetermined amount of pending data transactions in the second data path.

9. The method of claim 1, further comprising at least one of:
determining when to generate at least one bubble in the first data path based on the type associated with the trigger event;
determining for how long to generate at least one bubble in the first data path based on the type associated with the trigger event; and
determining how often to generate at least one bubble in the first data path based on the type associated with the trigger event.

10. A subsystem configured to manage starvation issues in a computing device, the subsystem comprising:
a starvation control engine configured to:
monitor data transactions issued to a destination device by a source device across one or more data paths;
detect a trigger event based on the monitored data transactions;
determine a type associated with the trigger event; and
generate at least one bubble in a first data path based on the type associated with the trigger event.

11. The subsystem of claim 10, wherein monitor data transactions comprises monitor data transactions issued to the destination device by the source device across the first data path.

12. The subsystem of claim 11, wherein the starvation control engine is further configured to stop or throttle the data transactions in the first data path to generate at least one bubble in the first data path.

13. The subsystem of claim 12, wherein the data transactions in the first data path comprise a stream of posted write transactions.

14. The subsystem of claim 10, wherein monitor data transactions comprises monitor data transactions issued to the destination device by the source device across a second data path.

15. The subsystem of claim 14, wherein the data transactions in the second data path comprise at least one pending non-posted read transaction.

16. The subsystem of claim 15, wherein the starvation control engine is further configured to stop or throttle a stream of posted write transaction in the first data path to generate at least one bubble in the first data path.

17. The subsystem of claim 10, wherein the starvation control engine is further configured to determine that the type associated with the trigger event comprises at least one of:
(1) a lapse of a predetermined amount of time or cycles;
(2) a processing of an unbroken stream data transactions in the first data path for a predetermined amount of time or cycles without processing a data transaction in a second data path;
(3) a processing of a predetermined number of data transactions in the first data path within a predetermined amount of time or cycles; and
(4) a non-processing of a predetermined amount of pending data transactions in the second data path.

18. The subsystem of claim 10, wherein the starvation control engine is further configured to at least one of:
determine when to generate at least one bubble in the first data path based on the type associated with the trigger event;
determine for how long to generate at least one bubble in the first data path based on the type associated with the trigger event; and
determine how often to generate at least one bubble in the first data path based on the type associated with the trigger event.

19. A computing device configured to manage starvation issues, the computing device comprising:
a destination device;
a source device in communication with the destination device via one or more data paths;
at least one arbiter configured to control data transactions communicated through the one or more data paths; and
a starvation control engine configured to:
monitor the data transactions issued to the destination device by the source device across the one or more data paths;
detect a trigger event based on the monitored data transactions;
determine a type associated with the trigger event; and
generate at least one bubble in a first data path based on the type associated with the trigger event.

20. The computing device of claim 19, wherein the starvation control engine is further configured to stop or throttle the data transactions in the first data path to generate at least one bubble in the first data path.

21. A subsystem configured to manage starvation issues in a computing device, the subsystem comprising:
a starvation control engine configured to generate at least one bubble in a first data path between a destination device and a source device,
wherein at least one of:
when to generate at least one bubble,
how long to generate at least one bubble, and
how often to generate at least one bubble is programmable via the starvation control engine.
